(19) United States
(12) Patent Application Publication
(10) Pub. No.: US 2017/0031308 A1
(43) Pub. Date: Feb. 2, 2017

(54) UNIT FOR IMAGE FORMING APPARATUS, PROCESS CARTRIDGE, AND IMAGE FORMING APPARATUS

(71) Applicant: FUJI XEROX CO., LTD., Tokyo (JP)

(72) Inventors: Manabu FURUKI, Kanagawa (JP); Masahiro UCHIDA, Kanagawa (JP); Masashi IKEDA, Kanagawa (JP); Makoto KAMISAKI, Kanagawa (JP); Sakiko HIRAI, Kanagawa (JP); Teppei YAWADA, Kanagawa (JP)

(73) Assignee: FUJI XEROX CO., LTD., Tokyo (JP)

(21) Appl. No.: 14/987,105

(22) Filed: Jan. 4, 2016

(30) Foreign Application Priority Data
Jul. 29, 2015 (JP) 2015-149890

(51) Int. Cl. G03G 21/18

(52) U.S. Cl. CPC G03G 21/1814

(57) ABSTRACT

A unit for an image forming apparatus includes a developing unit that includes a developing roll and a voltage applying section, and a cleaning unit that includes a cleaning blade which contacts with the image holding member and cleans a surface of the image holding member, wherein the developing roll is provided with an interval of 100 μm to 300 μm with respect to the image holding member, and holds an electrostatic charge image developer including a carrier and a toner whose a volume average particle diameter is 2 μm to 5 μm on a surface of the developing roll, and the voltage applying section applies an alternating voltage in which an alternating-current component is applied on a direct current component to the developing roll, the following expression being satisfied: 34≦Toner Volume Average Particle Diameter [μm]×Alternating-Current Component Frequency [kHz]≦60.

### CROSS-REFERENCE TO RELATED APPLICATIONS

This application is based on and claims priority under 35 USC 119 from Japanese Patent Application No. 2015-149890 filed Jul. 29, 2015.

### BACKGROUND

1. Technical Field

The present invention relates to a unit for an image forming apparatus, a process cartridge, and an image forming apparatus.

2. Related Art

Currently, a method of visualizing image information such as an electrophotographing method has been used in various fields. In the electrophotographing method, an electrostatic charge image is formed on the surface of an image holding member as the image information by charging and forming of an electrostatic charge image. Then, a toner image is formed on the surface of the image holding member by a developer including a toner, the toner image is transferred to a recording medium, and then the toner image is fixed to the recording medium. Through these steps, the image information is visualized as an image. Then, the image holding member is cleaned by a blade or the like before a toner image is formed again.

### SUMMARY

According to an aspect of the invention, there is provided a unit for an image forming apparatus, including:

an image holding member;

a developing unit that includes a developing roll and a voltage applying section; and

a cleaning unit that includes a cleaning blade which contacts with the image holding member and cleans a surface of the image holding member,

wherein the developing roll is provided with an interval of from 100 μm to 300 μm with respect to the image holding member, and holds an electrostatic charge image developer including a carrier and a toner whose a volume average particle diameter is from 2 μm to 5 μm on a surface of the developing roll,

the voltage applying section applies an alternating voltage in which an alternating-current component (AC) is superimposed on a direct current component (DC) to the developing roll, and

a product of a volume average particle diameter [μm] of the toner and a frequency [kHz] of the alternating-current component (AC) satisfies a relationship of Expression 1 described below:

34≦Toner Volume Average Particle Diameter [μm]×Alternating-Current Component Frequency [kHz]≦60. (Expression 1)

### BRIEF DESCRIPTION OF THE DRAWINGS

Exemplary embodiments of the present invention will be described in detail based on the following figures, wherein:

FIG. 1 is a schematic view illustrating an example of an image forming apparatus of the exemplary embodiment;

FIG. 2 is a schematic view enlargedly illustrating a developing device portion in the image forming apparatus illustrated in FIG. 1;

FIG. 3 is a schematic view enlargedly illustrating a portion in which a developing roll of the developing device portion illustrated in FIG. 2 and a photoreceptor are disposed at intervals;

FIG. 4 is a schematic view enlargedly illustrating a cleaning device portion of the image forming apparatus illustrated in FIG. 1; and

FIG. 5 is a schematic view for illustrating a pressurizing force of a cleaning blade in a cleaning device.

### DETAILED DESCRIPTION

Hereinafter, exemplary embodiments of a unit for an image forming apparatus, a process cartridge, and an image forming apparatus of the invention will be described in detail.

Unit for Image Forming Apparatus

A unit for an image forming apparatus according to the exemplary embodiment includes at least an image holding member, a developing unit, and a cleaning unit.

The developing unit includes a developing roll, and the developing roll holds an electrostatic charge image developer including a toner and a carrier on the surface and transfers the toner onto the surface of the image holding member to thereby develop an electrostatic charge image on the surface of the image holding member as a toner image. In addition, the cleaning unit includes the cleaning blade which contacts with the image holding member, and thus cleans the surface of the image holding member.

Then, in the exemplary embodiment, the developing roll is provided with an interval of 100 μm to 300 μm with respect to the image holding member, and an alternating voltage in which an alternating-current component (AC) is superimposed on a direct current component (DC) is applied to the developing roll from a voltage applying section (for example, a power source). In addition, an electrostatic charge image developer including a toner having a volume average particle diameter of 2 μm to 5 μm as the toner is stored in the developing unit.

Further, a product of a volume average particle diameter [μm] of the toner and a frequency [kHz] of the alternating-current component (AC) satisfies a relationship of Expression 1 described below.

34≦Toner Volume Average Particle Diameter [μm]×Alternating-Current Component Frequency [kHz]≦60. (Expression 1)

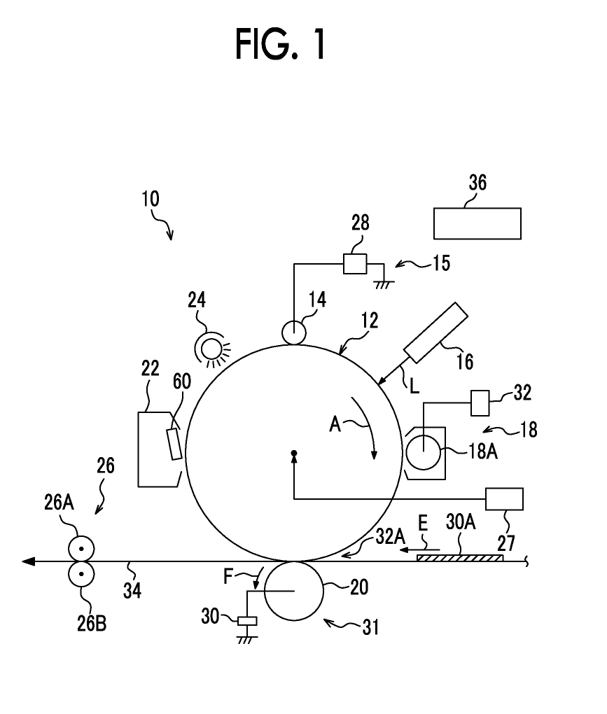

Here, an image forming apparatus including the unit for an image forming apparatus according to the exemplary embodiment will be described with reference to the drawings. FIG. 1 is a schematic configuration diagram illustrating an example of an image forming apparatus according to the exemplary embodiment.

As illustrated in FIG. 1, an image forming apparatus 10 according to the exemplary embodiment, for example, is provided with an electrophotographic photoreceptor (an example of the image holding member; hereinafter, also referred to as a “photoreceptor”) 12. The photoreceptor 12 is in the shape of a cylinder, is connected to a driving section 27 such as a motor through a driving force transmitting member (not illustrated) such as a gear, and is rotatably driven around a rotational axis illustrated by a black point by the driving section 27. In the example illustrated in FIG. 1, the photoreceptor 12 is rotatably driven in an arrow A direction.

For example, a charging device (an example of a charging unit) 15 including a contact type charging roll 14, a latent image forming apparatus (an example of an electrostatic charge image forming unit) 16, a developing device (an example of a developing unit) 18, a transfer device (an example of a transfer unit) 31, a cleaning device (an example of a cleaning unit) 22 including a cleaning blade 60, and an erasing device 24 are sequentially disposed along a rotation direction of the photoreceptor 12 in the vicinity of the photoreceptor 12. Then, a fixing device (an example of a fixing unit) 26 is also disposed in the image forming apparatus 10. In addition, the image forming apparatus 10 includes a control device 36 which controls the operation of each of the devices (each section).

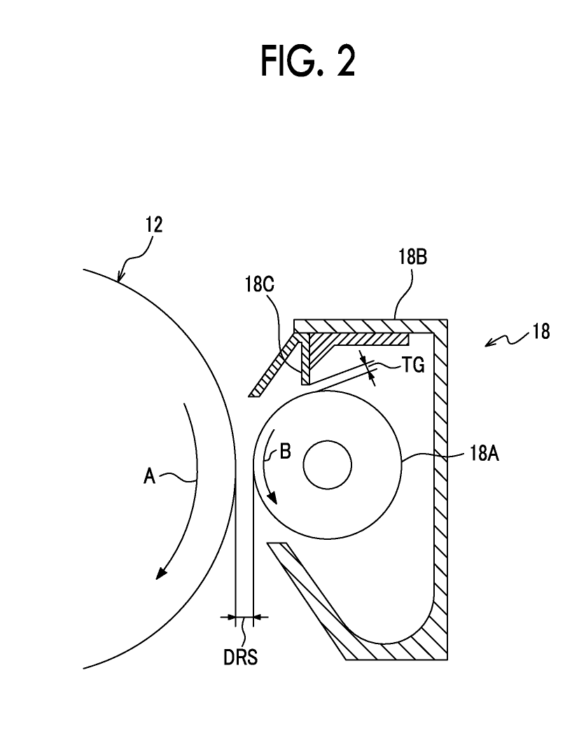

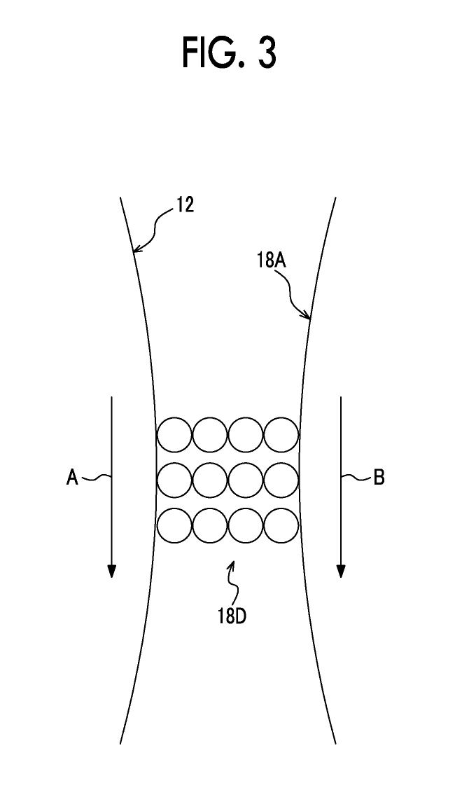

As illustrated in FIG. 2, the developing device 18 includes a developing roll 18A which is rotatably driven in an arrow B direction. The developing roll 18A is arranged such that an interval (gap) DRS (a distance between the developing roll 18A and the photoreceptor 12 (the shortest distance)) with respect to the photoreceptor 12 is formed, and in the exemplary embodiment, the interval DRS is set to be in a range of 100 μm to 300 μm. In addition, the developing roll 18A is disposed in a housing 18B in which an electrostatic charge image developer (not illustrated; hereinafter, also simply referred to as a “developer”) including a toner and a carrier is stored. An alternating voltage in which an alternating-current component (AC) is superimposed on a direct current component (DC) is applied to the developing roll 18A from a power source 32 as a developing bias. As illustrated in FIG. 3, according to the alternating voltage, a magnetic brush 18D is formed on the surface of the developing roll 18A by the carrier included in the developer, and the magnetic brush 18D is brought into contact with the photoreceptor 12, and thus a toner attached to the carrier (not illustrated) is supplied to the photoreceptor 12, and a latent image (an electrostatic charge image) formed on the surface of the photoreceptor 12 is developed as a toner image. Furthermore, the magnetic brush is configured of plural carriers which are linearly connected to be subjected to standing on the surface of the developing roll 18A and the toner attached to the carrier. In addition, in the housing 18B, a regulating member (a regulating trimmer) 18C for regulating the thickness of the magnetic brush 18D held on the developing roll 18A is provided with an interval TG (a distance between the developing roll 18A and the regulating member 18C (the shortest distance)).

Here, recently, from the viewpoint of obtaining a high definition image, adoption of a toner having a smaller diameter has been required, and in the exemplary embodiment, the toner having a volume average particle diameter of 2 μm to 5 μm (hereinafter, the toner will be referred to as a “toner with a small diameter”) is used as the toner.

However, in the toner with a small diameter, the charged amount per one particle of the toner decreases according to a decrease in diameter, and thus an electrostatic attachment force with respect to the photoreceptor (the image holding member) 12 is decreased, compared to a toner having a volume average particle diameter of greater than 5 μm (a toner with a large diameter). In addition, it is considered that a non-electrostatic attachment force with respect to the photoreceptor (the image holding member) 12 such as a van der Waals force (an intermolecular force) is increased, thereby making it becomes difficult to transfer the toner with a small diameter by a transfer electric field compared to the toner with a large diameter, and as a result thereof, fogging (a phenomenon in which the toner is transferred to not only an image portion but also a non-image portion) is easily caused.

In addition, in the toner, a releasing force (ease of detachment) decreases as the diameter becomes smaller, and specifically, the releasing force decreases with the cube of the value of a particle diameter. For this reason, the toner with a small diameter is more difficult to be detached from the carrier, as compared to the toner with a large diameter. In contrast, in the exemplary embodiment, the interval DRS between the developing roll 18A and the photoreceptor 12 is set to be in a range of 100 μm to 300 μm, that is, the developing roll 18A is arranged with a shorter interval DRS with respect to the photoreceptor 12. By setting the interval DRS to be shorter, for example, less than or equal to 300 μm, even when the toner with a small diameter which is hard to be detached from the carrier is used, the toner is efficiently detached from the carrier, and is transferred to the surface of the photoreceptor (the image holding member) 12. However, it is considered that when the interval DRS between the developing roll 18A and the photoreceptor 12 is short as described above, pressurization of the magnetic brush 18D with respect to a portion in which the electrostatic charge image is not formed increases, and thus the toner is easily transferred to the portion, that is, the fogging (jamming) is more easily caused.

From the viewpoint described above, the occurrence of the fogging is required to be prevented under conditions where the toner with a small diameter (the toner having a volume average particle diameter of 2 μm to 5 μm) is used, and the interval DRS between the developing roll 18A and the photoreceptor 12 is short, for example, less than or equal to 300 μm.

On the other hand, in image formation using the toner with a small diameter, the total developing amount of the toner used in developing of the electrostatic charge image decreases compared to the toner with a large diameter. For this reason, the amount of toner (when the toner further includes external additives, the amount of external additives is add) accumulated in a contact portion between the cleaning blade 60 of the cleaning device 22 and the photoreceptor 12 decreases, and thus cleaning performance may decrease.

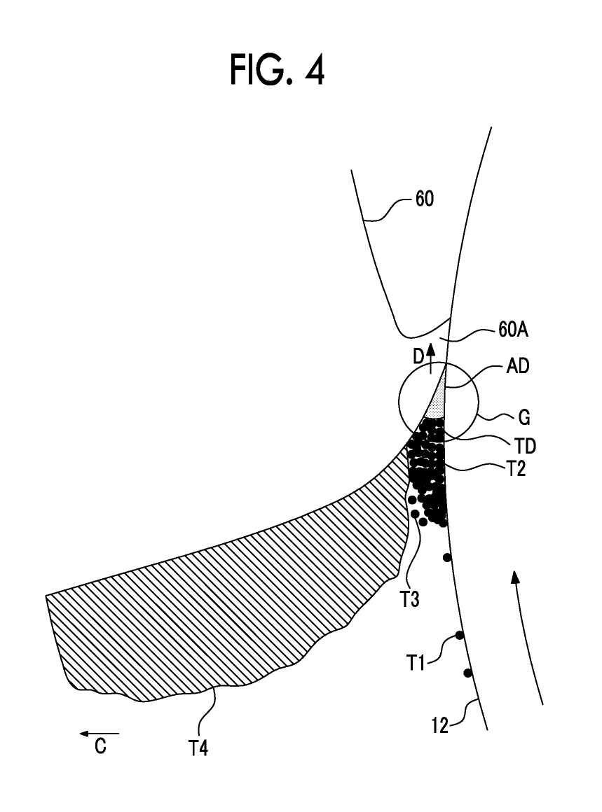

Here, a cleaning operation of the cleaning blade 60 with respect to the surface of the photoreceptor 12 will be described with reference to the drawings. Furthermore, a case where a toner to which external additives are externally added is used as the toner will be described as an example. FIG. 4 enlargedly illustrates a tip end portion of the cleaning blade 60 of the cleaning device 22, in which T1 is a residual toner (a toner remains on the surface of the photoreceptor 12 even after the toner image is transferred to a transfer member such as an intermediate transfer member or a recording medium), and 12 is a toner accumulated in a prenip of the cleaning blade 60 (on an upstream side of the contact portion). As illustrated in FIG. 4, an edge portion 60A of the cleaning blade 60 is deformed (deformed in an arrow D direction) by being pulled in the rotation direction (the arrow A direction) of the photoreceptor 12 due to a dynamic friction force which is generated between the surface of the photoreceptor 12 and the edge portion 60A of the cleaning blade 60 while the photoreceptor 12 is rotatably driven, and thus is in the shape of a wedge having a small tip end angle.

In cleaning by the cleaning blade 60, it is considered that a toner dam (a region in which the toner particles are accumulated) TD and an external additive dam (a region in which the particles of the external additives are accumulated) AD which are formed in the prenip effectively prevent the residual toner or the external additives from passing through the cleaning blade.

When the photoreceptor 12 is continuously rotatably driven, the external additives having a relatively small particle diameter which are released from the toner start to gather in the prenip and form the external additive dam AD, and the toner particles having a large particle diameter are collected in the external additive dam AD on the upstream side in the rotation direction of the photoreceptor 12 and form the toner dam TD. Then, in the prenip on the upstream side in the rotation direction of the photoreceptor 12, the toner (the toner particles) which has been continuously collected is not able to be accumulated in the prenip, and thus is sequentially moved (illustrated by T3 in FIG. 4), and is stacked in the tip end portion of the cleaning blade 60 (illustrated by T4 in FIG. 4). Then, when a toner T4 stacked in the tip end portion of the cleaning blade 60 is accumulated, the toner is moved to a side opposite to the photoreceptor 12 (an arrow C direction in FIG. 4) by being pressed from the prenip side, and then is separated from the tip end portion of the cleaning blade 60, and is removed to thereby perform cleaning.

However, when the toner with a small diameter is used, as described above, the total developing amount of the toner used in the developing of the electrostatic charge image is reduced, and thus the amount of residual toner accumulated in the toner dam TD (when the toner further contains the external additives, the amount of external additives accumulated in the external additive dam AD) is also reduced. As a result thereof, it is not possible to prevent the residual toner or the external additives from passing through the cleaning blade in the position of the cleaning device 22, and the cleaning performance may decrease.

Furthermore, when fogging occurs, that is, when the toner is also transferred to the non-image portion, the amount of toner which becomes the fogging increases in the total developing amount, compared to an image in which the fogging does not occur. As a result thereof, the amount of residual toner accumulated in the toner dam TD or the amount of external additives accumulated in the external additive dam AD in the contact portion with respect to the cleaning blade 60 also increases.

From the viewpoint as described above, in an aspect where the toner with a small diameter (the toner having a volume average particle diameter of 2 μm to 5 μm) is used, on the contrary, it is required that the fogging occurs from the viewpoint of the cleaning performance due to the toner dam TD or the external additive dam AD.

That is, the occurrence of the fogging is accelerated from the viewpoint of the cleaning performance while preventing the occurrence of the fogging in a range where the fogging is not recognized as a defect, for example, the fogging is not easily visually recognized from the viewpoint of an image quality defect in the formed image, and the occurrence of the fogging is required to be controlled in a range where a balance is obtained from both of the viewpoints.

In contrast, in the exemplary embodiment, the product of the volume average particle diameter [μm] of the toner and the frequency [kHz] of the alternating-current component (AC) satisfies the relationship of Expression 1 described above, and thus it is possible to prevent the occurrence of the image quality defect of the fogging in the image formed on the recording medium while exhibiting the excellent cleaning performance due to the cleaning blade.

The reason that this effect is obtained is not necessarily clear, but is assumed as follows.

It is found that the degree of fogging occurrence increases in inverse proportion to the particle diameter of the toner. It is considered that this is because the charged amount per one particle decreases as the particle diameter of the toner becomes smaller, and thus an electrostatic attachment force decreases.

In addition, it is found that the degree of fogging occurrence is affected by the frequency of the alternating-current component (AC) of the alternating voltage applied to the developing roll 18A. The toner is transferred from the developing roll 18A to the photoreceptor (the image holding member) 12 when an electric charge having a polarity opposite to that of the toner is applied to the developing roll 18A in the amount larger than that of a charging electric charge of the toner. In an aspect where the alternating voltage is applied to the developing roll 18A, the interval of times at which the toner is able to be transferred to the photoreceptor (the image holding member) 12 is shortened as the frequency of the alternating-current component (AC) becomes smaller, and thus, the fogging, that is, the toner is less likely to be transferred to the non-image portion.

However, the fogging is able to be controlled by the frequency of the alternating-current component (AC) according to the aspect in which the toner with a small diameter (the toner having a volume average particle diameter of 2 μm to 5 μm) is used, but in the toner with a large diameter in which the volume average particle diameter is greater than 5 μm, the influence is reduced.

Then, it is found that the product of the toner volume average particle diameter and the frequency of the alternating-current component is controlled such that the product is in the range of Expression 1 described above by adjusting both of the toner volume average particle diameter and the frequency of the alternating-current component of the alternating voltage, and thus the fogging occurs in the range where a balance is obtained, and as a result thereof, it is possible to achieve both preventing the image quality defect of the fogging in the image formed on the recording medium and exhibiting excellent cleaning performance of the cleaning blade.

Product of Toner Volume Average Particle Diameter and Alternating-Current Component Frequency (Expression 1)

The product of the toner volume average particle diameter [μm] and the alternating-current component frequency [kHz] is from 34 to 60, is more preferably from 38 to 57, and is even more preferably from 40 to 55.

When the value of the product denoted by Expression 1 is less than 34, the image quality defect of the fogging occurs in the image formed on the recording medium. In contrast, when the value of the product is greater than 60, the cleaning performance of the cleaning blade decreases, and foreign contaminants to be removed pass through the cleaning blade.

Next, the configuration of an image forming apparatus including the unit for an image forming apparatus according to the exemplary embodiment will be described in detail.

The image forming apparatus according to the exemplary embodiment includes the unit for an image forming apparatus according to the exemplary embodiment, a charging unit which charges the surface of the image holding member, an electrostatic charge image forming unit which forms the electrostatic charge image on the charged surface of the image holding member, a transfer unit which transfers the toner image formed on the surface of the image holding member onto the surface of the recording medium, and a fixing unit which fixes the toner image transferred onto the surface of the recording medium.

Here, in the image forming apparatus according to the exemplary embodiment, an image forming method including a charging step of charging the surface of the image holding member, an electrostatic charge image forming step of forming the electrostatic charge image on the charged surface of the image holding member, a developing step of developing the electrostatic charge image formed on the surface of the image holding member as a toner image by using the electrostatic charge image developer, a transfer step of transferring the toner image formed on the surface of the image holding member onto the surface of the recording medium, a cleaning step of cleaning the surface of the image holding member with the cleaning blade, and a fixing step of fixing the toner image transferred onto the surface of the recording medium is performed.

A known image forming apparatus such as a direct transfer type device which directly transfers the toner image formed on the surface of the image holding member onto the recording medium; an intermediate transfer type device which primarily transfers the toner image formed on the surface of the image holding member onto the surface of an intermediate transfer member, and secondarily transfers the toner image transferred onto the surface of the intermediate transfer member onto the surface of the recording medium; and a device including an erasing device which erases the toner image by irradiating the surface of the image holding member with erasing light after the toner image is transferred and before the charging is performed is applied to the image forming apparatus according to the exemplary embodiment.

In a case of the intermediate transfer type device, a configuration, for example, including an intermediate transfer member in which the toner image is transferred onto the surface, a primary transfer device which primarily transfers the toner image formed on the surface of the image holding member onto the surface of the intermediate transfer member, and a secondary transfer device which secondarily transfers the toner image transferred onto the surface of the intermediate transfer member onto the surface of the recording medium is applied to a transfer device.

Furthermore, in the image forming apparatus according to the exemplary embodiment, for example, a portion including at least the image holding member, the developing unit, and the cleaning unit may have a cartridge structure (a process cartridge) which is detachable from the image forming apparatus.

Furthermore, a process cartridge which includes the unit for an image forming apparatus according to the exemplary embodiment and is detachable from the image forming apparatus may be used.

Hereinafter, an example of the image forming apparatus according to the exemplary embodiment will be described with reference to the drawing, but the invention is not limited thereto.

FIG. 1 is a schematic configuration diagram illustrating an example of the image forming apparatus according to the exemplary embodiment.

As illustrated in FIG. 1, for example, the electrophotographic photoreceptor (an example of the image holding member; the photoreceptor) 12 is provided in the image forming apparatus 10 according to the exemplary embodiment. The photoreceptor 12 is in the shape of a cylinder, is connected to the driving section 27 such as a motor through a driving force transmitting member (not illustrated) such as a gear, and is rotatably driven around the rotational axis illustrated by the black point by the driving section 27. In the example illustrated in FIG. 1, the photoreceptor 12 is rotatably driven in the arrow A direction.

For example, the charging device (an example of the charging unit) 15 including the contact type charging roll 14, the latent image forming apparatus (an example of the electrostatic charge image forming unit) 16, the developing device (an example of the developing unit) 18, the transfer device (an example of the transfer unit) 31, the cleaning device (an example of the cleaning unit) 22 including the cleaning blade 60, and the erasing device 24 are sequentially provided along the rotation direction of the photoreceptor 12 in the vicinity of the photoreceptor 12. Then, the fixing device (an example of a fixing unit) 26 is also provided in the image forming apparatus 10. In addition, the image forming apparatus 10 includes the control device 36 which controls the operation of each of the devices (each of the sections).

The image forming apparatus 10 may be a process cartridge in which at least the photoreceptor 12, the developing device 18, and the cleaning device 22 are integrated. The process cartridge may be a process cartridge in which other devices are also integrated.

Photoreceptor

The photoreceptor 12, for example, includes a conductive substrate, an undercoat layer formed on the conductive substrate, and a photosensitive layer formed on the undercoat layer. The photosensitive layer may have a two-layer structure of a charge generating layer and a charge transport layer. The photosensitive layer may be an organic photosensitive layer, or may be an inorganic photosensitive layer. The photoreceptor 12 may have a configuration in which a protective layer is provided on the photosensitive layer.

Charging Device

The charging device 15 charges the surface of the photoreceptor 12. The charging device 15, for example, is provided to contact with the surface of the photoreceptor 12, and includes the charging member 14 charging the surface of the photoreceptor 12 and a power source 28 applying a charging voltage to the charging member 14 (an example of a voltage applying section for a charging member). The power source 28 is electrically connected to the charging member 14.

Examples of the charging member 14 of the charging device 15 include a contact type charging member using a conductive charging roller, a charging brush, a charging film, a charging rubber blade, a charging tube, and the like.

The charging device 15 (including the power source 28), for example, is electrically connected to the control device 36 provided in the image forming apparatus 10, the driving of the charging device is controlled by the control device 36, and the charging voltage is applied to the charging member 14. The charging member 14 to which the charging voltage is applied from the power source 28 charges the photoreceptor 12 at a charging potential according to the applied charging voltage. For this reason, the charging voltage applied from the power source 28 is adjusted, and thus the photoreceptor 12 performs the charging at a different charging potential.

Latent Image Forming Apparatus

The latent image forming apparatus 16 forms the electrostatic latent image on the charged surface of the photoreceptor 12. Specifically, for example, the latent image forming apparatus 16 is electrically connected to the control device 36 provided in the image forming apparatus 10, the driving of the latent image forming apparatus is controlled by the control device 36, the surface of the photoreceptor 12 which is charged by the charging member 14 is irradiated with light L modulated on the basis of image information of an image to be formed, and thus the electrostatic latent image is formed on the photoreceptor 12 according to the image of the image information.

Examples of the latent image forming apparatus 16 include an optical system apparatus or the like which includes a light source allowing an image to be exposed to light such as semiconductor laser light, LED light, and liquid crystal shutter light.

Developing Device

The developing device 18, for example, is provided on the downstream side in the rotation direction of the photoreceptor 12 from an irradiation position of the light L of the latent image forming apparatus 16. In the developing device 18, a storing portion storing a developer in the housing 18B is provided as illustrated in FIG. 2. In the storing portion, two-component electrostatic charge image developer including a toner carrier is stored. The toner, for example, is stored in the developing device 18 in a state of being charged. The developing device 18 is rotatably driven in the arrow B direction, and includes the developing roll 18A developing the electrostatic charge image formed on the surface of the photoreceptor 12 by the developer and the power source 32 as the voltage applying section which applies the alternating voltage to the developing roll 18A as developing bias. In addition, in the housing 18B, the regulating member (the regulating trimmer) 18C for regulating the thickness of the developer held on the developing roll 18A is provided with the interval TG (the distance between the developing roll 18A and the regulating member 18C (the shortest distance)).

Interval Between Developing Roll and Photoreceptor (Image Holding Member)

As illustrated in FIG. 2, the developing roll 18A has the interval (a gap) DRS (the distance between the developing roll 18A and the photoreceptor 12 (the shortest distance)) with respect to the photoreceptor 12. The interval DRS is set to be in a range of 100 μm to 300 μm, is more preferably from 200 μm to 280 μm, and is even more preferably from 220 μm to 260 μm.

When the interval (the gap) DRS between the developing roll 18A and the photoreceptor 12 is greater than 300 μm, and when the toner with a small diameter (the toner having a volume average particle diameter of 2 μm to 5 μm) is used, the toner is rarely detached from the carrier, and the amount of toner (the total developing amount) which is transferred to the electrostatic charge image on the surface of the photoreceptor 12 decreases. In contrast, when the interval (the gap) DRS is less than 100 μm, the pressurization of the magnetic brush with respect to the portion in which the electrostatic charge image is not formed increases, and thus the toner is easily transferred to the portion, that is the fogging (the jamming) more easily occurs.

Alternating Voltage

The alternating voltage in which the alternating-current component (AC) is superimposed on the direct current component (DC) is applied to the developing roll 18A from the power source as the developing bias. The frequency of the alternating-current component is preferably in a range of 5 kHz to 20 kHz, is more preferably in a range of 7 kHz to 15 kHz, and is even more preferably in a range of 8 kHz to 12 kHz, from the viewpoint of controlling the value of the product denoted by (Expression 1) described above such that the value is in the range described above and of adjusting the occurrence of the fogging.

Here, the developing roll 18A is selected from the type of developer, and examples of the developing roll 18A include a developing roll including a developing sleeve in which a magnet is embedded.

The developing device 18 (including the power source 32), for example, is electrically connected to the control device 36 provided in the image forming apparatus 10, the driving of the developing device 18 is controlled by the control device 36, and a developing voltage is applied to the developing roll 18A. The developing roll 18A to which the developing voltage is applied is charged at a developing potential according to the developing voltage. Then, the developing roll 18A charged at the developing potential, for example, holds the developer stored in the developing device 18 on the surface and supplies the toner included in the developer onto the surface of the photoreceptor 12 from the developing device 18. Furthermore, the carrier returns into the developing device 18 while being held in the developing roll 18A.

Transfer Device

The transfer device 31, for example, is provided on the downstream side in the rotation direction of the photoreceptor 12 from the position in which the developing roll 18A is provided. The transfer device 31, for example, includes a transfer member 20 transferring the toner image formed on the surface of the photoreceptor 12 to a recording medium 30A and a power source 30 applying a transfer voltage to the transfer member 20. The transfer member 20, for example, is in the shape of a cylinder, and in the example illustrated in FIG. 1, the transfer member 20 is rotated in an arrow F direction, and transports the recording medium 30A by interposing the recording medium 30A between the transfer member 20 and the photoreceptor 12. The transfer member 20, for example, is electrically connected to the power source 30.

Examples of the transfer member 20 include a contact type transfer charging member using a belt, a roller, a film, a rubber blade, and the like, and a known non-contact type transfer charging member such as a scorotron transfer charging member or a corotron transfer charging member using corona discharge.

The transfer device 31 (including the power source 30), for example, is electrically connected to the control device 36 provided in the image forming apparatus 10, the driving of the transfer device 31 is controlled by the control device 36, and the transfer voltage is applied to the transfer member 20. The transfer member 20 to which the transfer voltage is applied is charged at a transfer potential according to the transfer voltage.

When the transfer voltage having a polarity opposite to that of the toner configuring the toner image formed on the photoreceptor 12 is applied to the transfer member 20 from the power source 30 of the transfer member 20, for example, a transfer electric field having electric field intensity which moves each of the toners configuring the toner image on the photoreceptor 12 from the photoreceptor 12 to the transfer member 20 side by an electrostatic force is formed in a region (in FIG. 1, refer to transfer region 32A) in which the photoreceptor 12 faces the transfer member 20.

The recording medium 30A, for example, is stored in the storing portion (not illustrated), is transported by plural transport members (not illustrated) from the storing portion along a transport path 34, and reaches the transfer region 32A which is the region in which the photoreceptor 12 faces the transfer member 20. In the example illustrated in FIG. 1, the recording medium 30A is transported in an arrow E direction. The toner image on the photoreceptor 12 is transferred onto the recording medium 30A which has reached the transfer region 32A, for example, by the transfer electric field formed in the region by applying the transfer voltage to the transfer member 20. That is, for example, the toner is transferred from the surface of the photoreceptor 12 to the recording medium 30A, and thus the toner image is transferred onto the recording medium 30A.

The toner image on the photoreceptor 12 is transferred onto the recording medium 30A by the transfer electric field. The size of the transfer electric field is controlled on the basis of a transfer current value. The transfer current value is a current value which is detected by the transfer device 31 when the transfer electric field is applied by constant current control. The transfer current value indicates the size of the transfer electric field. For example, the transfer current value is from 10 μA to 45 μA.

Cleaning Device

The cleaning device 22 is configured of a housing and the cleaning blade 60 provided to project from the housing.

Furthermore, the cleaning blade 60 may be supported on an end portion of the housing, or may be supported by a separate support member (a holder), and in the exemplary embodiment, the cleaning blade is supported on the end portion of the housing.

The cleaning blade 60 will be described.

The cleaning blade 60 is in the shape of a plate which extends in a direction along the rotational axis of the photoreceptor 12, and is provided such that a tip end portion contacts with the photoreceptor 12 on the upstream side in the rotation direction (the arrow A) while applying a pressure thereto.

Examples of the material configuring the cleaning blade 60 include urethane rubber, silicon rubber, fluorine rubber, chloroprene rubber, butadiene rubber, and the like. Among them, the urethane rubber is preferable.

The urethane rubber (polyurethane) is not particularly limited insofar as, for example, the urethane rubber is used in general formation of polyurethane, and for example, urethane rubber containing an urethane prepolymer formed of polyol such as polyester polyol, for example, polyethylene adipate and polycaprolactone and isocyanate such as diphenyl methane diisocyanate, and for example, a cross-linking agent such as 1,4-butane diol, trimethylol propane, ethylene glycol, or a mixture thereof as a raw material is preferable.

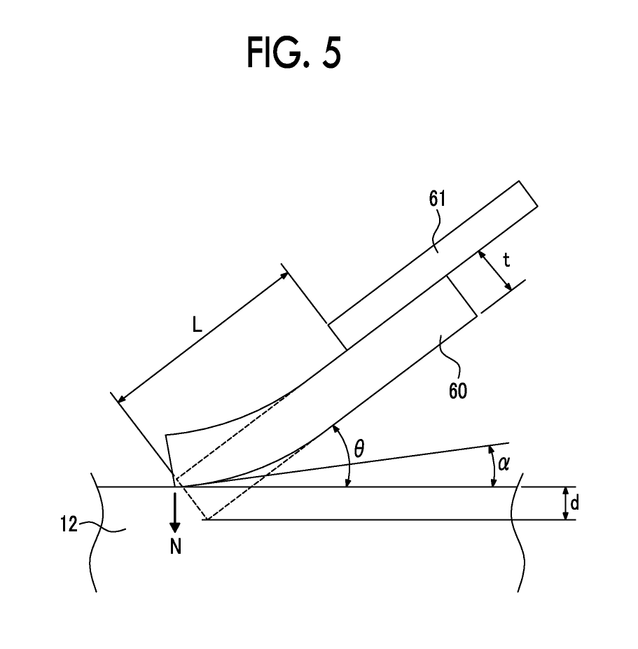

Here, as illustrated in FIG. 5, a blade load N of the cleaning blade 60 depends on a blade free length L, a blade thickness t, Young's modulus (hardness) of a blade material, a blade setting angle θ (a blade contact angle α), a blade biting amount d (a biting amount with respect to the photoreceptor 12), the specification of the toner used in the image forming apparatus, the specification of the photoreceptor 12, a charging type, the required lifetime of the member and the blade which contact with the photoreceptor 12, and the like, and in the exemplary embodiment, it is preferable that the blade load N is in a range of 1.5 gf/mm to 3.5 gf/mm.

In addition, it is preferable that the blade contact angle α is from 8° to 12°.

Here, the blade load N of the cleaning blade 60 is calculated by the following expression.

N=dEt³/4L³ Expression:

Here, d represents a blade biting amount, E represents a blade Young's modulus, t represents a blade thickness, and L represents a blade free length.

Erasing Device

The erasing device 24, for example, is provided on the downstream side in the rotation direction of the photoreceptor 12 from the cleaning device 22. The erasing device 24 erases the toner by allowing the surface of the photoreceptor 12 to be exposed to light after the toner image is transferred. Specifically, for example, the erasing device 24 is electrically connected to the control device 36 provided in the image forming apparatus 10, the driving of the erasing device 24 is controlled by the control device 36, and the entire surface of the photoreceptor 12 (specifically, for example, the entire surface of an image forming region) is exposed to light and is erased.

Examples of the erasing device 24 include a device including a light source such as a tungsten lamp emitting white light and a light emitting diode (LED) emitting red light.

Fixing Device

The fixing device 26, for example, is provided on the downstream side in a transport direction of the transport path 34 of the recording medium 30A from the transfer region 32A. The fixing device 26, for example, fixes the toner image transferred onto the recording medium 30A. Specifically, for example, the fixing device 26 is electrically connected to the control device 36 provided in the image forming apparatus 10, the driving of the fixing device 26 is controlled by the control device 36, and the toner image transferred on-to the recording medium 30A is fixed onto the recording medium 30A by heat or heat and pressure.

Examples of the fixing device 26 include a known fixing member such as a heat roller fixing member and an oven fixing member.

Here, the recording medium 30A onto which the toner image is transferred by transporting the recording medium 30A along the transport path 34 and by allowing the recording medium 30A to pass through the region in which the photoreceptor 12 faces the transfer member 20 (the transfer region 32A), for example, reaches the position in which the fixing device 26 is provided by being further transported along the transport path 34 by the transport member (not illustrated), and the toner image on the recording medium 30A is fixed.

The recording medium 30A on which an image is formed by fixing the toner image is ejected to the outside of the image forming apparatus 10 by the plural transport members (not illustrated). Furthermore, the photoreceptor 12 is charged again by the charging device 15 at a charging potential after the toner is erased by the erasing device 24.

Control Device

The control device 36 is configured as a computer which controls the entire device and performs various operations. Specifically, the control device 36 includes a central processing unit (CPU), a read only memory (ROM) in which various programs are stored, a random access memory (RAM) which is used as a work area at the time of executing a program, anon-volatile memory in which various information items are stored, an input and output interface (I/O), and the like.

Electrostatic Charge Image Developer

Next, the developer (the electrostatic charge image developer) which is used in the image forming apparatus 10 according to the exemplary embodiment having such a configuration and is stored in the housing 18B of the developing device 18 will be described.

The developer used in the exemplary embodiment is a two-component developer including a toner and a carrier. Then, a toner having a reduced diameter is adopted in the exemplary embodiment from the viewpoint of obtaining a high definition image, and specifically, the volume average particle diameter of the toner (that is, the volume average particle diameter of the toner particles included in the toner) is from 2 μm to 5 μm. The volume average particle diameter of the toner is more preferably from 3 μm to 5 μm, and is even more preferably from 4 μm to 5 μm.

Furthermore, when the volume average particle diameter of the toner is less than 2 μm, the amount of electric charge per one toner becomes insufficient, the fogging easily occurs, a releasing force from the carrier decreases, and a required developing amount is not able to be ensured. In addition, the external additive dam in the contact portion between the cleaning blade and the image holding member also decreases, a load with respect to the cleaning blade increases, and a defect that the cleaning performance deteriorates occurs.

The volume average particle diameter of the toner is the volume average particle diameter of the toner particles, and is measured by COULTER MULTISIZER II (manufactured by Beckman Coulter, Inc.) using ISOTON-II (manufactured by Beckman Coulter, Inc.) as an electrolyte.

In the measurement, as a dispersant, a measurement sample is added to 2 ml of aqueous solution of 5% of a surfactant (sodium alkyl benzene sulfonate is preferable) in the amount of 0.5 mg to 50 mg. The dispersant is added into 100 ml to 150 ml of an electrolyte.

The electrolyte in which the sample is suspended is subjected to a dispersion treatment for 1 minute by using an ultrasonic dispersion machine, and a particle diameter distribution of the particles having a particle diameter in a range of 2 μm to 60 μm is measured by COULTER MULTISIZER II using an aperture of 100 μm is used as an aperture diameter. Furthermore, the number of particles to be sampled is 50,000.

A cumulative distribution of each volume is plotted from a small diameter side with respect to a particle diameter range (a channel) divided on the basis of the particle diameter distribution to be measured, and a particle diameter at which the cumulation is 50% is defined as a volume average particle diameter D50v.

The toner of the exemplary embodiment is configured by containing the toner particles, and may include external additives.

Toner Particles

First, the toner particles will be described.

The toner particles, for example, are configured by including a binder resin, as necessary, a coloring agent, a release agent, and other additives.

Binder Resin

Examples of the binder resin include vinyl resins formed of homopolymers of monomers such as styrenes (for example, styrene, parachlorostyrene, and α-methylstyrene), (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propylmethacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers obtained by combining two or more kinds of these monomers.

Examples of the binder resin also include a non-vinyl resin such as an epoxy resin, a polyester resin, a polyurethane resin, a polyamide resin, a cellulose resin, a polyether resin, and modified rosin, mixtures thereof with the above-described vinyl resin, or graft polymer obtained by polymerizing a vinyl monomer with the coexistence of such non-vinyl resins.

These binder resins may be used singly or in combination of two or more kinds thereof.

As the binder resin, a polyester resin is appropriate.

As the polyester resin, for example, a well-known polyester resin is included.

Examples of the polyester resin include condensation polymers of polyvalent carboxylic acids and polyols. A commercially available product or a synthesized product may be used as the polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these substances, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used singly or in combination of two or more types thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with diol. Examples of the tri- or higher-valent polyol include glycerin, trimethylolpropane, and pentaerythritol.

The polyol may be used singly or in combination of two or more types thereof.

The glass transition temperature (Tg) of the polyester resin is preferably from 50° C. to 80° C., and more preferably from 50° C. to 65° C.

The glass transition temperature is obtained by a DSC curve which is obtained by a differential scanning calorimetry (DSC), and more specifically, is obtained by “Extrapolating Glass Transition Starting Temperature” disclosed in a method for obtaining the glass transition temperature of “Testing Methods for Transition Temperatures of Plastics” in JIS K-7121-1987.

The weight-average molecular weight (Mw) of the polyester resin is preferably in a range from 5,000 to 1,000, 000, and more preferably in a range from 7,000 to 500,000.

The number-average molecular weight (Mn) of the polyester resin is preferably in a range from 2,000 to 100,000.

A molecular weight distribution Mw/Mn of the polyester resin is preferably in a range from 1.5 to 100, and more preferably in a range from 2 to 60.

The weight-average molecular weight and the number-average molecular weight are measured by using gel permeation chromatography (GPC). Molecular weight measurement by using GPC is performed by using HLC-8120GPC (GPC manufactured by TOSOH Corporation) as a measurement device, by using TSKGEL SUPERHM-M (15 cm) (column manufactured by TOSOH Corporation), and by using a THF solvent. The weight-average molecular weight and the number-average molecular weight are calculated by using a molecular weight calibration curve which is created based on this measurement result by using a monodisperse polystyrene standard sample.

The polyester resin is obtained by a known preparing method. Specific examples thereof include a method of performing a reaction at a polymerization temperature set to be in a range of from 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is performed while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

The content of the binder resin is, for example, preferably in a range of from 40% by weight to 95% by weight, more preferably in a range of from 50% by weight to 90% by weight, and further preferably in a range of from 60% by weight to 85% by weight relative to the entire toner particles.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorant may be used singly or in combination of two or more types thereof.

If necessary, the colorant may be surface-treated or used in combination with a dispersing agent. Plural types of colorants may be used in combination.

The content of the colorant is, for example, preferably in a range of from 1% by weight to 30% by weight, and more preferably in a range of from 3% by weight to 15% by weight relative to the entire toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters; and the like. The release agent is not limited to these examples.

A melting temperature of the release agent is preferably in a range from 50° C. to 110° C., and more preferably in a range from 60° C. to 100° C.

The melting temperature is obtained from a DSC curve obtained by differential scanning calorimetry (DSC). More specifically, the melting temperature is obtained from “Melting Peak Temperature” described in the method of obtaining a melting temperature in JIS K 7121-1987 “Testing Methods for Transition Temperatures of Plastics”.

The content of the release agent is, for example, preferably in a range of from 1% by weight to 20% by weight, and more preferably in a range of from 5% by weight to 15% by weight relative to the entire toner particles.

Other Additives

Examples of other additives include known additives such as a magnetic material, a charge controlling agent, and inorganic powder. The toner particles contain these additives as internal additives.

Characteristics of Toner Particles

The toner particles may be toner particles having a single-layer structure, or be toner particles having a so-called core/shell structure composed of a core (core particle) and a coating layer (shell layer) coated on the core. Here, toner particles having a core/shell structure is preferably composed of, for example, a core containing a binder resin, and if necessary, other additives such as a colorant and a release agent and a coating layer containing a binder resin.

The shape factor SF1 of the toner particles is preferably from 110 to 150, and more preferably from 120 to 140.

The shape factor SF1 is obtained through the following expression.

SF1=(ML²/A)×(π/4)×100 Expression:

In the foregoing expression, ML represents an absolute maximum length of a toner, and A represents a projected area of a toner.

Specifically, the shape factor SF1 is numerically converted mainly by analyzing a microscopic image or a scanning electron microscopic (SEM) image by using of an image analyzer, and is calculated as follows. That is, an optical microscopic image of particles scattered on a surface of a glass slide is input to an image analyzer LUZEX through a video camera to obtain maximum lengths and projected areas of 100 particles, values of SF1 are calculated through the foregoing expression, and an average value thereof is obtained.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The inorganic particles may be particles including silica, that is, SiO₂ as a main component, and may be crystalline or amorphous. In addition, the silica particles may be particles prepared by using a silicon compound such as water glass or alkoxy silane as a material, or may be particles obtained by pulverizing quartz.

Specifically, examples of the silica particles include sol-gel silica particles, aqueous colloidal silica particles, alcoholic silica particles, fumed silica particles obtained by a vapor phase method, and spherical silica particles.

Surfaces of the inorganic particles as an external additive are preferably subjected to a hydrophobizing treatment with a hydrophobizing agent. The treatment with a hydrophobizing agent is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used singly or in combination of two or more kinds thereof.

A compound having a melting point of lower than 20° C., that is, a compound which is in a liquid state at 20° C. is preferable as oil for performing a surface treatment with respect to the inorganic particles (the silica particles are particularly preferable), and examples of the compound include a compound one or more compounds selected from a group consisting of a lubricant and fat and oil. Specifically, examples of the surface treatment oil include silicone oil, paraffin oil, fluorine oil, vegetable oil, and the like. One type of surface treatment oil may be used, or plural types thereof may be used.

Examples of the silicone oil include dimethyl silicone oil (dimethyl polysiloxane), diphenyl silicone oil (diphenyl polysiloxane), methyl phenyl silicone oil (methyl phenyl polysiloxane), chlorophenyl silicone oil (chlorophenyl polysiloxane), methyl hydrogen silicone oil (methyl hydrogen polysiloxane), alkyl-modified silicone oil (alkyl-modified polysiloxane), fluorine-modified silicone oil (fluorine-modified polysiloxane), polyether-modified silicone oil (polyether-modified polysiloxane), alcohol-modified silicone oil (alcohol-modified polysiloxane), amino-modified silicone oil (amino-modified polysiloxane), epoxy-modified silicone oil (epoxy-modified polysiloxane), epoxy.polyether-modified silicone oil (epoxy.polyether-modified polysiloxane), phenol-modified silicone oil (phenol-modified polysiloxane), carboxyl-modified silicone oil (carboxyl-modified polysiloxane), mercapto-modified silicone oil (mercapto-modified polysiloxane), acryl.methacryl-modified silicone oil (acryl.methacryl-modified polysiloxane), 1-methyl styrene-modified silicone oil (1-methyl styrene-modified polysiloxane), higher fatty acid-modified silicone oil (higher fatty acid-modified polysiloxane), methyl styryl-modified silicone oil (methyl styryl-modified polysiloxane), and the like.

Examples of the paraffin oil include liquid paraffin, and the like.

Examples of the fluorine oil include fluorine oil, fluorine chloride oil, and the like.

Examples of the mineral oil include machine oil, and the like.

Examples of the vegetable oil include rapeseed oil, palm oil, and the like.

The silicone oil is preferable as the surface treatment oil from the viewpoint of improving cleaning properties by forming the external additive dam. In addition, among the silicone oil, dimethyl silicone oil is more preferable as the surface treatment oil from the viewpoint of improving cleaning properties by forming the external additive dam.

Examples of a method of performing the surface treatment with respect to the inorganic particles by using the surface treatment oil include a dry method such as a spray and dry method in which the surface treatment oil or a solution including the surface treatment oil is sprayed to the inorganic particles floating in a vapor phase, a wet method in which the inorganic particles are dipped in the surface treatment oil or a solution including the surface treatment oil, and then are dried, a mixing method in which the surface treatment oil and the inorganic particles are mixed by a mixing machine, and the like.

The inorganic particles are dipped again in a solvent such as ethanol after being subjected to the surface treatment by the method or the like using the surface treatment oil, and the solvent is dried, and thus residual surface treatment oil, low boiling point residues, and the like may be removed.

The amount of surface treatment oil (a treatment amount) used in the surface treatment of the inorganic particles is preferably from 1 parts by weight to 30 parts by weight, is more preferably from 3 parts by weight to 15 parts by weight, and is even more preferably from 5 parts by weight to 12 parts by weight, with respect to 100 parts by weight of the silica particles, from the viewpoint of improving cleaning properties of the cleaning blade.

The number average particle diameter of the inorganic particles is preferably from 70 nm to 150 nm, is more preferably from 75 nm to 140 nm, and is even more preferably from 80 nm to 130 nm.

The number average particle diameter is a particle diameter of primary particles of the inorganic particles. Furthermore, the number average particle diameter is obtained by an equivalent circle diameter (Heywood diameter) using microscopy based on JIS Z 8901, and a scanning type electron microscope (SEM) is used as a microscope.

By setting the number average particle diameter of the inorganic particles to be in the range described above, the inorganic particles are easily detached from the toner particles, the amount of external additives sufficient for forming the external additive dam is obtained, and a uniformly close external additive dam is easily formed, compared to a case where the number average particle diameter of the inorganic particles is less than the range described above. In addition, by setting the number average particle diameter of the inorganic particles to be in the range described above, a decrease in charging properties and moving properties of the toner due to excessive detachment of the inorganic particles from the toner particles rarely occurs, compared to a case where the number average particle diameter of the inorganic particles is greater than the range described above.

The externally added amount (the added amount) of the inorganic particles is preferably from 0.3 parts by weight to 3.0 parts by weight, and is more preferably from 0.5 parts by weight to 1.0 part by weight, with respect to 100 parts by weight of the toner particles. By setting the added amount of the inorganic particles to be in the range described above, the inorganic particles are sufficiently supplied to the external additive dam, and thus the cleaning properties of the cleaning blade become excellent, compared to a case where the added amount of the inorganic particles is less than the range described above, and a defective image due to a decrease in toner fluidity is prevented, compared to a case where the added amount of the inorganic particles is greater than the range described above.

Examples of the external additive also include resin particles (resin particles such as polystyrene, polymethyl methacrylate (PMMA), and melamine resin particles) and a cleaning aid (for example, metal salt of higher fatty acid represented by zinc stearate, and fluorine polymer particles).

Method of Preparing Toner

Next, a method of preparing the toner will be described. The toner is obtained by externally adding an external additive to toner particles after preparing the toner particles.

The toner particles may be prepared using any of a dry preparing method (for example, kneading and pulverizing method) and a wet preparing method (for example, aggregation and coalescence method, suspension and polymerization method, and dissolution and suspension method). The toner particle preparing method is not particularly limited to these preparing methods, and a known preparing method is employed.

Among these methods, the toner particles may preferably be obtained by the aggregation and coalescence method.

Specifically, for example, when the toner particles are prepared by an aggregation and coalescence method, the toner particles are prepared through the processes of: preparing a resin particle dispersion in which resin particles as a binder resin are dispersed (resin particle dispersion preparation process); aggregating the resin particles (if necessary, other particles) in the resin particle dispersion (if necessary, in the dispersion after mixing with other particle dispersions) to form aggregated particles (aggregated particle forming process); and heating the aggregated particle dispersion in which the aggregated particles are dispersed, to coalesce the aggregated particles, thereby forming toner particles (coalescence process).

Hereinafter, the respective processes will be described in detail.

In the following description, a method of obtaining toner particles including a colorant and a release agent will be described. However, the colorant and the release agent are used if necessary. Additives other than the colorant and the release agent may be used.

—Resin Particle Dispersion Preparation Process—

For example, a colorant particle dispersion in which colorant particles are dispersed and a release agent particle dispersion in which release agent particles are dispersed are prepared with a resin particle dispersion in which resin particles as a binder resin are dispersed.

The resin particle dispersion is prepared by, for example, dispersing resin particles in a dispersion medium using a surfactant.

Examples of the dispersion medium used for the resin particle dispersion include aqueous mediums.

Examples of the aqueous mediums include water such as distilled water and ion exchange water, and alcohols. These may be used singly or in combination of two or more kinds thereof.

Examples of the surfactant include anionic surfactants such as a sulfuric ester salt, a sulfonate, a phosphate ester, and a soap; cationic surfactants such as an amine salt and a quaternary ammonium salt; and nonionic surfactants such as polyethylene glycol, an ethylene oxide adduct of alkyl phenol, and polyol. Among these, anionic surfactants and cationic surfactants are particularly preferably used. Nonionic surfactants may be used in combination with anionic surfactants or cationic surfactants.

The surfactants may be used singly or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a DYNO mill having media is exemplified. Depending on the kind of the resin particles, resin particles may be dispersed in the resin particle dispersion according to, for example, a phase inversion emulsification method.

The phase inversion emulsification method includes: dissolving a resin to be dispersed in a hydrophobic organic solvent in which the resin is soluble; conducting neutralization by adding abase to an organic continuous phase (O phase); and converting the resin (so-called phase inversion) from W/O to O/W by putting an aqueous medium (W phase) to form a discontinuous phase, thereby dispersing the resin as particles in the aqueous medium.

A volume average particle diameter of the resin particles dispersed in the resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the smallest diameter with respect to particle size ranges (channels) separated using the particle size distribution obtained by the measurement with a laser diffraction-type particle size distribution measuring device (for example, LA-700 manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

For example, the colorant particle dispersion and the release agent particle dispersion are also prepared in the same manner as in the preparation of the resin particle dispersion. That is, the particles in the resin particle dispersion are the same as the colorant particles dispersed in the colorant particle dispersion and the release agent particles dispersed in the release agent particle dispersion, in terms of the volume average particle diameter, the dispersion medium, the dispersing method, and the content of the particles in the resin dispersion.

—Aggregated Particle Forming Process—

Next, the colorant particle dispersion and the release agent dispersion are mixed together with the resin particle dispersion.

Then, the resin particles, the colorant particles, and the release agent particles are heterogeneously aggregated in the mixed dispersion, thereby forming aggregated particles having a diameter close to a target toner particle diameter and including the resin particles, the colorant particles, and the release agent particles.

Specifically, for example, an aggregating agent is added to the dispersion mixture and a pH of the dispersion mixture is adjusted to be acidic (for example, the pH is from 2 to 5). If necessary, a dispersion stabilizer is added. Then, the dispersion mixture is heated at the glass transition temperature of the resin particles (specifically, for example, from a temperature 30° C. lower than the glass transition temperature of the first resin particles to a temperature 10° C. lower than the glass transition temperature thereof) to aggregate the particles dispersed in the dispersion mixture, and thereby the aggregated particles are formed.

In the aggregated particle forming process, for example, the aggregating agent may be added at room temperature (for example, 25° C.) under stirring of the dispersion mixture using a rotary shearing-type homogenizer, the pH of the dispersion mixture may be adjusted to be acidic (for example, the pH is from 2 to 5), a dispersion stabilizer may be added if necessary, and then the heating may be performed.

Examples of the aggregating agent include a surfactant having an opposite polarity to the polarity of the surfactant used as the dispersing agent to be added to the mixed dispersion, an inorganic metal salt, and a bi- or higher-valent metal complex. Particularly, when a metal complex is used as the aggregating agent, the amount of the surfactant used is reduced and charging characteristics are improved.

If necessary, an additive may be used which forms a complex or a similar bond with the metal ions of the aggregating agent. A chelating agent is preferably used as the additive.

Examples of the inorganic metal salt include a metal salt such as calcium chloride, calcium nitrate, barium chloride, magnesium chloride, zinc chloride, aluminum chloride, and aluminum sulfate, and inorganic metal salt polymer such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

An addition amount of the chelating agent is, for example, preferably in a range of from 0.01 parts by weight to 5.0 parts by weight, and more preferably in a range of from 0.1 parts by weight to less than 3.0 parts by weight relative to 100 parts by weight of the first resin particles.

—Coalescence Process—

Next, the aggregated particle dispersion in which the aggregated particles are dispersed is heated at, for example, a temperature that is equal to or higher than the glass transition temperature of the resin particles (for example, a temperature that is higher than the glass transition temperature of the resin particles by 10° C. to 30° C.) to coalesce the aggregated particles and form toner particles.

Toner particles are obtained through the foregoing processes.

After the aggregated particle dispersion in which the aggregated particles are dispersed is obtained, toner particles may be prepared through the processes of: further mixing the resin particle dispersion in which the resin particles are dispersed with the aggregated particle dispersion to conduct aggregation so that the resin particles further adhere to the surfaces of the aggregated particles, thereby forming second aggregated particles; and coalescing the second aggregated particles by heating a second aggregated particle dispersion in which the second aggregated particles are dispersed, thereby forming toner particles having a core-shell structure.

After the coalescence process is ended, toner particles formed in a solution are subjected to a well-known washing process, a well-known solid-liquid separation process, a well-known drying process, and thereby dried toner particles are obtained.

Regarding the washing process, replacing washing using ion exchanged water may preferably be sufficiently performed for charging property. The solid-liquid separation process is not particularly limited, but suction filtration, pressure filtration, or the like may preferably be performed for productivity. The drying process is not particularly limited, but freeze drying, flash jet drying, fluidized drying, vibrating fluidized drying, and the like may preferably be performed for productivity.

The toner in this exemplary embodiment is prepared, for example, by adding an external additive to the obtained toner particles in a dried state, and performing mixing. The mixing may be performed, for example, by using a V blender, a HENSCHEL mixer, a Lodige mixer, or the like. Furthermore, if necessary, coarse toner particles may be removed using a vibration sieving machine, a wind classifier, or the like.

Electrostatic Charge Image Developer

An electrostatic charge image developer according to the exemplary embodiment is a two-component developer in which the toner and the carrier are mixed.

The carrier is not particularly limited, and known carriers may be used. Examples of the carrier include a coated carrier in which surface of core formed of a magnetic powder is coated with a coating resin; a magnetic powder dispersion-type carrier in which a magnetic powder is dispersed and blended in a matrix resin; and a resin impregnation-type carrier in which a porous magnetic powder is impregnated with a resin.

The magnetic powder dispersion-type carrier and the resin impregnation-type carrier may be carriers in which constituent particles of the carrier are cores which are coated with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic ester copolymer, a straight silicone resin configured to include an organosiloxane bond or a modified product thereof, a fluororesin, polyester, polycarbonate, a phenol resin, and an epoxy resin.

The coating resin and the matrix resin may contain other additives such as conductive particles.

Examples of the conductive particles include particles of metal such as gold, silver, and copper, and particles of carbon black, titanium oxide, zinc oxide, tin oxide, barium sulfate, aluminum borate, potassium titanate, and the like.

Here, a coating method using a coating layer forming solution in which a coating resin, and if necessary, various additives are dissolved in an appropriate solvent is used to coat the surface of a core with the coating resin. The solvent is not particularly limited, and may be selected in consideration of the coating resin to be used, coating suitability, and the like.

Specific examples of the resin coating method include a dipping method of dipping cores in a coating layer forming solution, a spraying method of spraying a coating layer forming solution to surfaces of cores, a fluid bed method of spraying a coating layer forming solution in a state in which cores are allowed to float by flowing air, and a kneader-coater method in which cores of a carrier and a coating layer forming solution are mixed with each other in a kneader-coater and the solvent is removed.

The mixing ratio (weight ratio) between the specific toner and the carrier in the two-component developer is preferably from 1:100 to 30:100, and more preferably from 3:100 to 20:100 (toner:carrier).

Furthermore, the particle diameter (the volume average particle diameter) of the carrier used in the exemplary embodiment is preferably in a range of 1:3 to 1:10, and is more preferably in a range of 1:5 to 1:7, in a ratio of the carrier to the toner (Toner Particle Diameter:Carrier Particle Diameter).

The operation of the image forming apparatus 10 according to the exemplary embodiment having the configuration as described above will be described.

The operation of the image forming apparatus 10 is performed according to the control executed in the control device 36. First, the surface of the photoreceptor 12 is charged by the charging device 15. The latent image forming apparatus 16 allows the charged surface of the photoreceptor 12 to be exposed to light on the basis of the image information. Accordingly, the electrostatic charge image according to the image information is formed on the photoreceptor 12. In the developing device 18, the electrostatic charge image formed on the surface of the photoreceptor 12 is developed by the developer including the toner. Accordingly, the toner image is formed on the surface of the photoreceptor 12. In the transfer device 31, the toner image formed on the surface of the photoreceptor 12 is transferred to the recording medium 30A. The toner image transferred to the recording medium 30A is fixed by the fixing device 26, and thus the image is formed. On the other hand, the surface of the photoreceptor 12 after the toner image is transferred is cleaned (swept) by the cleaning device 22, and is erased by the erasing device 24.

### EXAMPLES

Hereinafter, examples of the invention will be described, but the invention is not limited to the examples.

As an image forming apparatus in the examples described below a modified machine prepared by modifying an image forming apparatus, Product Name: DOCUCENTRE-IV C5570, manufactured by Fuji Xerox Co., Ltd. such that an interval (a gap) between a photoreceptor (an image holding member) and a developing roll and a frequency of an alternating-current component of an alternating voltage applied to the developing roll from a power source are able to be freely adjusted.

In addition, a used developer is prepared as follows.

Preparation of Developer 1

Preparation of Polyester Resin (A1) and Polyester Resin

### Particle Dispersion (a1)

15 parts by mole of polyoxy ethylene (2,0)-2,2-bis(4-hydroxy phenyl) propane, 85 parts by mole of polyoxy propylene (2,2)-2,2-bis(4-hydroxy phenyl) propane, 10 parts by mole of terephthalic acid, 67 parts by mole of fumaric acid, 3 parts by mole of n-dodecenyl succinic acid, 20 parts by mole of trimellitic acid, and 0.05 parts by mole of dibutyl tin oxide with respect to an acid component thereof (the total number of moles of terephthalic acid, n-dodecenyl succinic acid, trimellitic acid, and fumaric acid) are put into a heated and dried two neck flask, nitrogen gas is introduced into the container, the container is maintained in an inert atmosphere and is heated, and then a copolycondensation reaction is performed at 150° C. to 230° C. for 12 hours to 20 hours. After that, pressure is slowly reduced at 210° C. to 250° C., and thus a polyester resin (A1) is synthesized. A weight average molecular weight Mw of the resin is 65,000, and a glass transition temperature Tg of the resin is 65° C.

3,000 parts by weight of the obtained polyester resin, 10,000 parts by weight of ion exchange water, and 90 parts by weight of a surfactant, sodium dodecyl benzene sulfonate are put into an emulsification tank of a high temperature and high pressure emulsification device (CAVITRON CD1010, Slit: 0.4 mm), and then are heated and melted at 130° C., are rotated 10,000 times at a flow rate of 3 L/m and a temperature of 110° C. and are dispersed for 30 minutes, and pass through a cooling tank, an amorphous resin particle dispersion is collected, and thus a polyester resin particle dispersion (a1) is obtained.

Preparation of Polyester Resin (B1) and Polyester Resin

### Particle Dispersion (b1)

45 parts by mole of 1,9-nonane diol, 55 parts by mole of dodecane dicarboxylic acid, and 0.05 parts by mole of dibutyl tin oxide as a catalyst are put into a heated and dried three neck flask, and then the air in the container is under an inert atmosphere by nitrogen gas according to a pressure reducing operation, and the mixture is mechanically stirred at 180° C. for 2 hours. After that, the temperature is slowly increased to 230° C. under reduced pressure and the stirring is performed for 5 hours, and at the time when the mixture is in a viscous state, air cooling is performed to stop the reaction. Thus, a polyester resin (B1) is synthesized. A weight average molecular weight Mw of the resin is 25,000, and a melt temperature Tm of the resin is 73° C.

After that, a polyester resin dispersion (b1) is obtained by using the high temperature and high pressure emulsification device (CAVITRON CD1010, Slit: 0.4 mm) in the same conditions as those in the preparation of the polyester resin dispersion (A1).

Preparation of Coloring Agent Particle Dispersion
Cyan Pigment (manufactured by Dainichiseika Color & Chemicals Mfg. Co., Ltd., C.I. Pigment Blue 15:3 (Copper Phthalocyanine)): 1,000 parts by weight
Anionic Surfactant NEOGEN SC (manufactured by DKS Co., Ltd.): 150 parts by weight
Ion Exchange Water: 4,000 parts by weight

The components described above are mixed and dissolved, are dispersed for 1 hour by using a high pressure impact type dispersion machine ULTIMIZER (HJP30006, manufactured by SUGINO MACHINE LIMITED.), and thus a coloring agent particle dispersion formed by dispersing a coloring agent (cyan pigment) particles is prepared. The volume average particle diameter of the coloring agent (cyan pigment) particles in the coloring agent particle dispersion is 0.15 μm, and the concentration of a coloring agent particle is 20%.

Preparation of Release Agent Particle Dispersion
Release Agent (WEP-2, manufactured by NOF CORPORATION): 100 parts by weight
Anionic Surfactant NEOGEN SC (manufactured by DKS Co., Ltd.): 2 parts by weight
Ion Exchange Water: 300 parts by weight
Fatty Acid Amide Wax (manufactured by Nippon Fine Chemical, Neutron D: 100 parts by weight
Anionic Surfactant (manufactured by NOF CORPORATION, NEUREX R): 2 parts by weight
Ion Exchange Water: 300 parts by weight

The components described above are heated at 95° C., are dispersed by using a homogenizer (ULTRA-TURRAX T50, manufactured by IKA Laboratory Technology), and are subjected to a dispersion treatment by using a pressure discharge type Gaulin homogenizer (manufactured by Manton Gaulin Manufacturing Co., Inc.), and thus a release agent particle dispersion (1) (concentration of the release agent: 20% by weight) formed by dispersing release agent particles having a volume average particle diameter of 200 nm is prepared.

Preparation of Toner Particles 1
Polyester Resin Particle Dispersion (a1): 340 parts by weight
Polyester Resin Particle Dispersion (b1): 160 parts by weight
Coloring Agent Particle Dispersion: 50 parts by weight
Release Agent Particle Dispersion: 60 parts by weight
Surfactant Aqueous Solution: 10 parts by weight
0.3M Nitric Acid Aqueous Solution: 50 parts by weight
Ion Exchange Water: 500 parts by weight

The components described above are put into a rounded stainless steel flask, are dispersed by using a homogenizer (ULTRA-TURRAX T50, manufactured by IKA Laboratory Technology), and then are heated to 42° C. in an oil bath for heating and are held for 30 minutes, and are further heated to 58° C. in an oil bath for heating and are held for 30 minutes, and at the time when the formation of aggregated particles is confirmed, 100 parts by weight of an additional polyester resin particle dispersion (al) are added and further held for 30 minutes.

Subsequently, 3% by weight of a trisodium salt of nitrilotriacetic acid (manufactured by Chelest Corporation, CHELEST 70) with respect to the total solution is added. After that, a 1 N sodium hydroxide aqueous solution is slowly added until pH of the solution reaches 7.2, and the resultant is heated to 85° C. with continuous stirring and is then held for 3.0 hours. After that, a reaction product is filtered, is washed with ion exchange water, and is then dried by using a vacuum drier, and thus toner particles 1 are obtained.

At this time, the particle diameter is measured by a COULTER MULTISIZER, and the volume average particle diameter is 4.7 μm.

Preparation of Inorganic External Additives

### (Oil-treated Silica) 1

SiCl₄, hydrogen gas, and oxygen gas are mixed in a mixing chamber of a combustion burner and are burned at a temperature of 1,000° C. to 3,000° C., a silica powder is obtained from the gas after being burned, and thus a silica base material is obtained. At this time, a molar ratio of the hydrogen gas and the oxygen gas is set to 1.3:1, and thus silica particles (1) having a volume average particle diameter of 136 nm are obtained.

100 parts of the silica particles (1) and 500 parts of ethanol are put into an evaporator, and are stirred for 15 minutes while adjusting the temperature to 40° C. Next, 10 parts of dimethyl silicone oil (Model Number: KM351, manufactured by Shin-Etsu Chemical Co., Ltd.) with respect to 100 parts of the silica particles is put thereto and stirred for 15 minutes, and then 10 parts of dimethyl silicone oil with respect to 100 parts of the silica particles is further put thereto and stirred for 15 minutes. Finally, the temperature is increased to 90° C. and the ethanol is dried under reduced pressure, and then a treatment product is obtained and subjected to vacuum drying at 120° C. for 30 minutes, and thus oil-treated silica particles 1 having a number average particle diameter of 136 nm and containing a free oil in an amount of 10% by weight are obtained.

Preparation of Toner 1

0.50 parts of oil-treated silica, 2.50 parts of silica particles untreated with oil (Number Average Particle Diameter: 140 nm) as other external additives, and 1.50 parts of titania particles (Number Average Particle Diameter: 20 nm) are added with respect to 100 parts of the toner particles 1, and are mixed at a peripheral rate of 30 m/s for 15 minutes by using a HENSCHEL mixer having a volume of 5 liters, and then coarse particles are removed by using a sieve having an aperture size of 45 μm, and thus a toner 1 is prepared.

Carrier 1

100 parts by weight of ferrite particles (manufactured by Powdertech Co., Ltd., Average Particle Diameter of 50 μm) and 1.5 parts by weight of a methyl methacrylate resin (manufactured by Mitsubishi Rayon Co., Ltd., Molecular Weight of 95,000, and Component Ratio of Component Having Molecular Weight of less than 10,000 of 5% by weight), along with 500 parts by weight of toluene, are put into a pressurization type kneader, are stirred and mixed at normal temperature (25° C.) for 15 minutes, are heated to 70° C. while being mixed under reduced pressure such that toluene is distilled off, and then are cooled. The resultant is classified by using a sieve of 105 μm, and thus a ferrite carrier covered with a resin (a carrier 1) is obtained.

Developer 1

The toner and the ferrite carrier covered with a resin which are obtained as described above are mixed such that the concentration of a toner is 7% by weight, and thus a developer 1 is prepared.

### Example 1

An evaluation test described below is performed by setting the interval (DRS/μm) between the photoreceptor (the image holding member) and the developing roll in the image forming apparatus, the frequency (kHz) of the alternating-current component of the alternating voltage applied to the developing roll from the power source, and the volume average particle diameter (μm) of the toner as shown in Table 1 below.

### Examples 2 to 9 and Comparative Examples 1 to 16

An evaluation test described below is performed by the same method as that in Example 1 except that the interval (DRS/μm) between the photoreceptor (the image holding member) and the developing roll in the image forming apparatus, the frequency (kHz) of the alternating-current component of the alternating voltage applied to the developing roll from the power source, and the volume average particle diameter (μm) of the toner are changed as shown in Table 1 below.

Evaluation Test

Blade Maintainability

An evaluation test with respect to blade maintainability (cleaning performance) is performed by the following method. The results are shown in Table 1 below.

Test Method

The average image density is divided into two levels of a low image density of 1.8% and a high image density of 14%, and an inflow current of a contact type charging roll (a bias charging roll, BCR) is set to be 1.4 times a current value at which a white point of a halftone image disappears, and the test is performed until the total number of rotations of the photoreceptor becomes 50,000 cycles. After the test is performed, a cleaning blade is measured by using a laser microscope VK9500 (manufactured by KEYENCE CORPORATION), and an abrasive area of a contact surface with the photoreceptor in a sectional direction is measured. Furthermore, evaluation is performed at each of the image densities.

Evaluation Criteria

A: ≦5 μm²

B: >5 μm² and ≦10 μm²

C: >10 μm²

Fogging

An evaluation test with respect to the occurrence of fogging in the image formed on the recording medium is performed by the following method. The results are show in Table 1 below.

Test Method

In a background portion of which the potential is ⅓ of a developing potential at the time of having an image density of 1.5, the degree of the occurrence of the fogging in the background portion is evaluated on the basis of the following criteria.

Evaluation Criteria

A: The occurrence of the fogging is not visually observed.

B: The occurrence of the fogging is slightly visually observed.

C: The occurrence of the fogging is clearly visually observed.

Developing Amount

An evaluation test with respect to the total developing amount of the toner is performed by the following method. The results are shown in Table 1 below.

Test Method

The density of the image on the recording medium (paper) is measured by using X-RITE (manufactured by X-Rite Inc.) under conditions where the developing potential at the time of having an image density of 1.5 is less than the maximum potential difference on the performance of the photoreceptor. In addition, the granularity of the halftone is evaluated on the basis of the following criteria.

Evaluation Criteria

A: 1.25≦the density≦1.85, and no defect in the granularity of the halftone is visually observed.

B: 1.25≦the density≦1.85, and a defect in the granularity of the halftone which is able to be visually observed occurs.

C: the density<1.25

TABLE 1

| | | Toner Volume | Alternating-Current | | | | |
|---|---|---|---|---|---|---|---|
| | | Average Particle | Component | | | | |
| | DRS | Diameter [φ] | Frequency [f] | | Blade | | Developing |
| | (μm) | (μm) | (kHz) | [φ] × [f] | Maintainability | Fogging | Amount |
| Example 1 | 250 | 3.8 | 15 | 57 | B | A | A |
| Example 2 | 280 | 3.8 | 9 | 34.2 | A | B | A |
| Example 3 | 250 | 4.7 | 9 | 42.3 | A | B | A |
| Example 4 | 280 | 5 | 9 | 45 | A | B | A |
| Example 5 | 250 | 3.5 | 15 | 52.5 | B | B | A |
| Example 6 | 280 | 3.8 | 15 | 57 | B | A | A |
| Example 7 | 250 | 3.8 | 12 | 45.6 | B | A | A |
| Example 8 | 250 | 3.8 | 9 | 34.2 | A | B | A |
| Example 9 | 250 | 4.7 | 12 | 56.4 | A | A | A |
| Comparative | 250 | 4.7 | 15 | 70.5 | C | A | A |
| Example 1 | | | | | | | |
| Comparative | 350 | 3.8 | 9 | 34.2 | B | A | C |
| Example 2 | | | | | | | |
| Comparative | 400 | 6 | 8 | 48 | A | B | B |
| Example 3 | | | | | | | |
| Comparative | 250 | 4.7 | 6 | 28.2 | A | C | A |
| Example 4 | | | | | | | |
| Comparative | 250 | 6 | 15 | 90 | C | A | B |
| Example 5 | | | | | | | |
| Comparative | 250 | 3.5 | 18 | 63 | C | A | A |
| Example 6 | | | | | | | |
| Comparative | 250 | 3.5 | 7 | 24.5 | A | C | A |
| Example 7 | | | | | | | |
| Comparative | 250 | 3.8 | 18 | 68.4 | C | A | A |
| Example 8 | | | | | | | |
| Comparative | 250 | 3.8 | 8 | 30.4 | A | C | A |
| Example 9 | | | | | | | |
| Comparative | 250 | 3.8 | 6 | 22.8 | A | C | A |
| Example 10 | | | | | | | |
| Comparative | 250 | 4.7 | 15 | 70.5 | C | A | A |
| Example 11 | | | | | | | |
| Comparative | 250 | 4.7 | 6 | 28.2 | A | C | A |
| Example 12 | | | | | | | |
| Comparative | 400 | 5.8 | 15 | 87 | C | A | A |
| Example 13 | | | | | | | |
| Comparative | 400 | 5.8 | 9 | 52.2 | A | A | B |
| Example 14 | | | | | | | |
| Comparative | 400 | 5.8 | 8 | 46.4 | A | A | B |
| Example 15 | | | | | | | |
| Comparative | 400 | 5.8 | 6 | 34.8 | A | A | B |
| Example 16 | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A unit for an image forming apparatus, comprising:
an image holding member;
a developing unit that includes a developing roll and a voltage applying section; and
a cleaning unit that includes a cleaning blade which contacts with the image holding member and cleans a surface of the image holding member,
wherein the developing roll is provided with an interval of from 220 μm to 260 μm with respect to the image holding member and holds an electrostatic charge image developer including a carrier and a toner whose volume average particle diameter is from 2 μm to 5 μm on a surface of the developing roll,
the voltage applying section applies an alternating voltage in which an alternating-current component (AC) is superimposed on a direct current component (DC) to the developing roll, and
a product of a volume average particle diameter [μm] of the toner and a frequency [kHz] of the alternating-current component (AC) satisfies a relationship of Expression 1:
34≦Toner Volume Average Particle Diameter [μm]×Alternating-Current Component Frequency [kHz]≦60. (Expression 1)

2. The unit for an image forming apparatus according to claim 1,
wherein the product of the volume average particle diameter [μm] of the toner and the frequency [kHz] of the alternating-current component (AC) satisfies Expression 2:
38≦Toner Volume Average Particle Diameter [μm]×Alternating-Current Component Frequency [kHz]≦57. (Expression 2)

3. (canceled)

4. The unit for an image forming apparatus according to claim 1,
wherein the alternating-current component is in a range of from 7 kHz to 15 kHz.

5. The unit for an image forming apparatus according to claim 1,
wherein a blade contact angle α of the cleaning blade is from 8° to 12°.

6. A process cartridge which is detachable from an image forming apparatus, comprising:
the unit for an image forming apparatus according to claim 1.

7. An image forming apparatus, comprising:
the unit according to claim 1;
a charging unit that charges a surface of the image holding member;
an electrostatic charge image forming unit that forms an electrostatic charge image on a charged surface of the image holding member;
a transfer unit that transfers a toner image formed on the surface of the image holding member onto a surface of a recording medium; and
a fixing unit that fixes the toner image transferred onto the surface of the recording medium.

8. The image forming apparatus according to claim 7,
wherein a product of a volume average particle diameter [μm] of a toner and a frequency [kHz] of an alternating-current component (AC) satisfies Expression 2:
38≦Toner Volume Average Particle Diameter [μm]×Alternating-Current Component Frequency [kHz]≦57. (Expression 2)

9. (canceled)

10. The image forming apparatus according to claim 7,
wherein the alternating-current component is in a range of from 7 kHz to 15 kHz.

11. The image forming apparatus according to claim 7,
wherein a blade contact angle α of the cleaning blade is from 8° to 12°.
